(19) United States
(12) Patent Application Publication
(10) Pub. No.: US 2003/0107518 A1
(43) Pub. Date: Jun. 12, 2003

(54) Folded shorted patch antenna

(76) Inventors: RongLin Li, Atlanta, GA (US); Joy Laskar, Atlanta, GA (US); Emmanouil Tentzeris, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/222,440

(22) Filed: Aug. 16, 2002

Related U.S. Application Data
(60) Provisional application No. 60/340,977, filed on Dec. 12, 2001.

(51) Int. Cl. H01Q 1/24

(52) U.S. Cl. 343/702; 343/846

(57) ABSTRACT

A patch antenna is described that includes a ground plane, a first shorting structure in contact with the ground plane, a first conductor plate in contact with the first shorting structure. The patch antenna can also include a second shorting structure in contact with the ground plane, and a second conductor plate in contact with the second shorting structure and forming a radiation slot with the first conductor plate. Other devices and methods are herein provided for.

### CROSS-REFERENCE TO RELATED APPLICATION

This application claims priority to copending U.S. provisional application entitled, “SIZE-REDUCED FOLDED SHORTED-PATCH ANTENNA FOR WIRELESS COMMUNICATIONS,” having Ser. No. 60/340,977, filed 12/12/2001, which is entirely incorporated herein by reference.

### TECHNICAL FIELD

The present invention is generally related to communications, and, more particularly, is related to antennas.

### BACKGROUND OF THE INVENTION

In modern mobile and wireless communications systems, there is an increasing demand for smaller low-cost antennas. This is especially true for handheld wireless applications, such as in mobile phone handsets or Bluetooth chips, where a package-integrated antenna may be desirable. It is well known that planar structures such as microstrip patch antennas have a significant number of advantages over conventional antennas, such as low profile, light weight and low production cost. However, in some practical wireless communications systems such as Global System for Mobile Communications (GSM) 1800, Personal Communications Service (PCS) 1900, wideband code division multiple access standard IMT 2000, or Bluetooth ISM (Industrial, Scientific, and Medical), the physical size of planar structures may be too large for integration with radio frequency (RF) devices.

One type of antenna suitable for use with personal communications devices is the conventional patch antenna 100, shown in a side view in FIG. 1. The patch antenna 100 (here a λ₀/2 patch antenna) comprises a ground plane 102, a patch (or a conductor plate) 104, and a feed 106. It is well known that a conventional patch antenna operating at the fundamental mode, Transverse Magnetic (TM) mode TM₀₁, has an antenna length of ˜λ₀/2. The length of the patch is set in relation to a wavelength λ₀ associated with the resonant frequency f₀. A number of techniques have been proposed to reduce the size of conventional half-wave (λ₀/2, where λ₀ is the guide wavelength in the substrate) patch antennas. One approach is to use a high dielectric constant substrate (e.g., between the patch 104 and the ground plane 102). However, such an approach often leads to poor efficiency and narrow bandwidth.

Shorting structures (e.g., shorting posts, shorting walls) also have been used in different arrangements to reduce the overall size of the patch antenna. Considering that the electric field is zero for the TM₀₁ mode at the middle of the patch 104, the patch 104 along its middle line can be shorted with a metal wall without significantly changing the resonant frequency of the patch antenna 100. FIG. 2 illustrates a conventional shorted patch antenna 200 that includes a patch 204 that is shorted to the ground plane 202 with a metal wall 208. This shorted patch antenna 200 includes a patch 204 with a length of λ₀/4. Further patch size reduction measures include using a shorting pin (not shown) near the feed 206. The size-reduction technique using a shorting pin has been applied to the design of small patch antennas for 3G IMT-2000 mobile handsets.

A planar invert-F antenna (PIFA) is one of the most well-known and documented small patch antennas. Actually, the PIFA can be viewed as a shorted-patch antenna. Therefore the antenna length of a PIFA is generally less than λ₀/4. When a shorting post is located at a corner of a square plate, the length of the PIFA can be reduced to λ₀/8. The size of a PIFA can be also reduced by loading it. Recent research efforts on the size reduction of patch antennas have focused on patch-shape optimization to increase the effective electric length of the patch. For example, by notching a rectangular patch, the antenna length can be reduced to less than λ₀/8. A printed antenna with a surface area 75% smaller than a conventional microstrip patch was obtained by incorporating strategically positioned notches near a shorting pin. However, the demand for a further reduction in size while preserving or improving some performance characteristics of larger antennas still exists.

Thus, a need exists in the industry to address the aforementioned and/or other deficiencies and inadequacies.

### SUMMARY OF THE INVENTION

The preferred embodiments of the present invention provide for a patch antenna. Briefly described, one embodiment of the patch antenna, among others, can be implemented as follows. The patch antenna includes a ground plane, a first shorting structure in contact with the ground plane, a first conductor plate in contact with the first shorting structure, a second shorting structure in contact with the ground plane, and a second conductor plate in contact with the second shorting structure and forming a radiation slot with the first conductor plate.

The preferred embodiments of the present invention also include, among others, a method for making a patch antenna. One method can generally be described by the following steps: connecting a first conductor plate to a ground plane with a first shorting structure, the first conductor plate substantially parallel to the ground plane, the first conductor plate having an electrical length of approximately λ₀/16; and connecting a second conductor plate to the ground plane with a second shorting structure, the second conductor plate substantially parallel to the first conductor plate, the second conductor plate having an electrical length of approximately λ₀/16, the second conductor plate forming a radiation slot with the first conductor plate.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a side view of a prior art patch antenna.

FIG. 2 is a side view of a prior art shorted patch antenna.

FIGS. 3A-3B are front and rear view schematic diagrams of a portable telephone that incorporates a folded shorted patch (FSP) antenna, in accordance with one embodiment of the invention.

FIGS. 4A-4B are side views demonstrating one method for making the FSP antenna of FIG. 3B, in accordance with one embodiment of the invention.

FIG. 5A is an isometric view of the FSP antenna depicted in FIG. 4B, in accordance with one embodiment of the invention.

FIG. 5B is a Smith chart showing the input impedance of the FSP antenna of FIG. 5A fed at different lower patch locations, in accordance with one embodiment of the invention.

FIGS. 6-8 are graphs showing the effect on return loss and resonant frequency when modifying the shape parameters of the FSP antenna of FIG. 5A, in accordance with one embodiment of the invention.

FIGS. 9A-9B are graphs showing the radiation patterns of the FSP antenna of FIG. 5A after modifying the height parameters, in accordance with one embodiment of the invention.

FIGS. 10A-10C are side views illustrating the process of unfolding a folded shorted patch (S-P) antenna to arrive at a transmission model, in accordance with one embodiment of the invention.

FIG. 10D is the transmission model of the unfolded S-P antenna derived from unfolding operations depicted in FIGS. 10A-10C, in accordance with one embodiment of the invention.

FIGS. 11A-11C are Smith charts comparing the theoretical and numerical input impedance of the unfolded S-P antennas and folded S-P antennas depicted in FIGS. 10A-10C, in accordance with one embodiment of the invention.

FIG. 12 is a graphical illustration of the suseptance and capacitance versus various resonant frequencies of the unfolded S-P antennas and folded S-P antennas depicted in FIGS. 10A-10C, in accordance with one embodiment of the invention.

FIG. 13 is a graph showing the simulated results for input impedance versus frequency for the FSP antenna using a lumped capacitor, in accordance with an alternate embodiment of the invention.

FIG. 14 is a graph showing the difference between simulated and measured return loss versus resonance frequency for one example FSP antenna implementation, in accordance with one embodiment of the invention.

FIGS. 15A-15B are graphs showing the radiation patterns of the simulated versus measured results of the FSP implementation described in association with FIG. 14, in accordance with one embodiment of the invention.

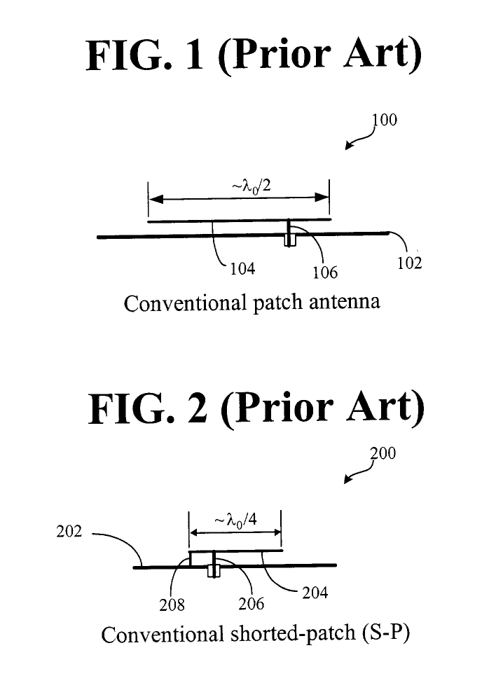

### DETAILED DESCRIPTION OF THE PREFERRED EMBODIMENTS

The preferred embodiments of the invention now will be described more fully hereinafter with reference to the accompanying drawings. One way of understanding the preferred embodiments of the invention includes viewing them within the context of a personal communications device, and more particularly within the context of an antenna for a portable telephone. However, it is noted that the preferred embodiments can be viewed within other contexts, such as for use in cellular handsets, sensors for monitoring, and wireless smart cards, among other example contexts that use antennas for transmitting and/or receiving signals over a medium.

In the description that follows, a folded shorted patch (FSP) antenna will be described that is reduced in size compared to conventional patch antennas. By folding a shorted rectangular patch, the resonant length of the antenna can be reduced from ˜λ₀/4 to ˜λ₀/8. A further decrease of as much as more than 50% in the resonant length may be achieved through adjusting the width of the shorting walls and the heights of the folded patches. Thus the overall electrical length (less than λ₀/16) of the FSP antenna can be eight times shorter than the length of a conventional patch (˜λ₀/2). A brief note about the term electrical length can be described as follows. For example, if a patch with a physical length of 150 millimeters (mm) can operate at 1 gigahertz (GHz) (λ₀=300 mm), then the electrical length of this patch will be understood to be λ₀/2. But if the patch with the same physical length (150 mm) can operate at 500 megahertz (MHz) (λ₀=600 mm), the electrical length of the same patch is now λ₀/4.

A structure of the FSP antenna for a personal communications device will be described below. One method for making the FSP antenna will also be described, as well as some numerical simulations described that are recorded in a series of graphs illustrating input impedance, radiation patterns, and the effect on return loss and resonant frequency when various elements of the FSP antenna are modified. This discussion is followed by a theoretical analysis based on a transmission-line model created by unfolding a folded shorted patch antenna, and then a comparison of the theoretical versus numerical simulations is discussed and illustrated. The FSP antenna operation for reducing resonant frequency is analyzed by considering the antenna as a shorted patch loaded with a capacitive device, followed by an example implementation of an FSP antenna.

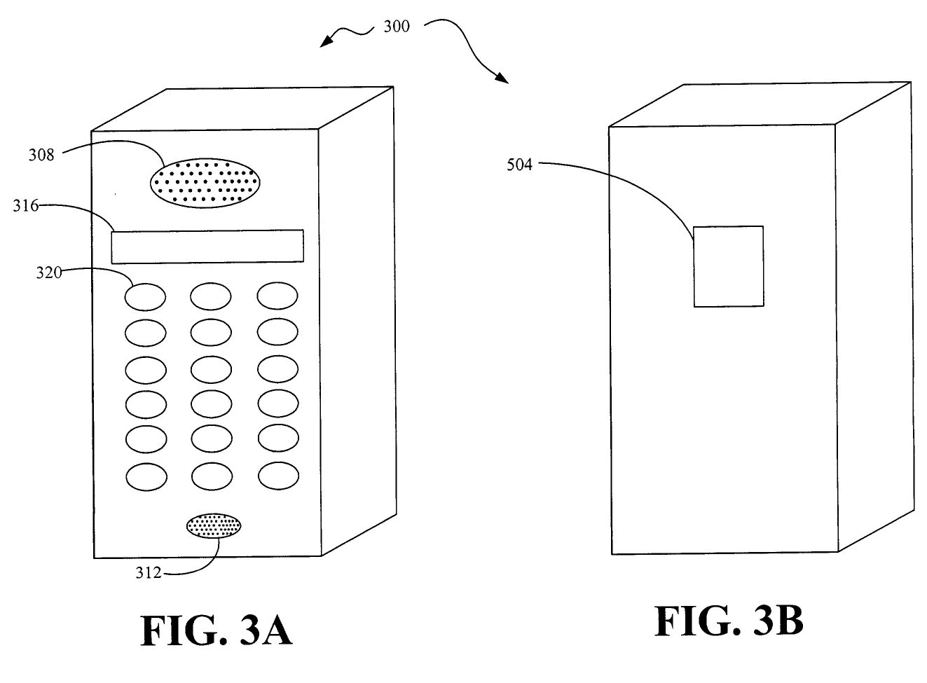

FIGS. 3A and 3B illustrate one example implementation for the FSP antenna. Specifically, FIG. 3A depicts a front view of a portable phone 300 having a speaker 308, a microphone 312, a display 316, and a keyboard 320, as well as internal transceiver circuitry not shown. FIG. 3B is a rear view of the portable phone 300 shown in FIG. 3A showing an FSP antenna 504 preferably mounted to the back of the portable phone 300 to reduce the specific absorption rate (SAR) potentially absorbed in the head of a user. The length of the FSP antenna 504 determines its resonant frequency. For example, a quarter wave (i.e., λ₀/4) patch antenna having a length L will resonate at a frequency of c/4L, where c equals the speed of light. At or near the resonant frequency is where the FSP antenna 504, or patch antennas in general, radiate most effectively.

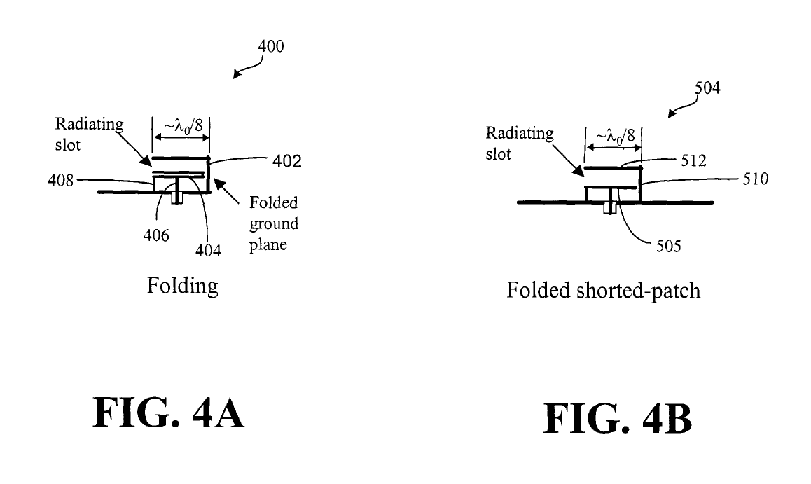

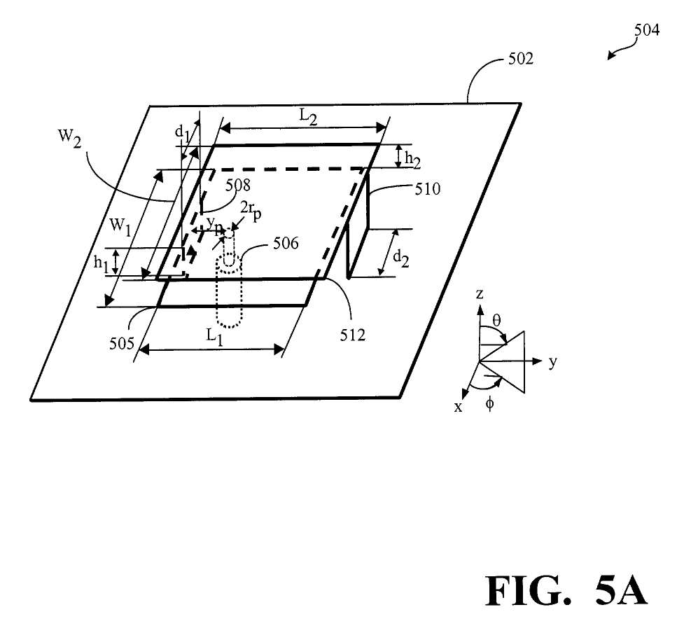

FIGS. 4A-4B show a series of side views demonstrating one mechanism for making the FSP antenna structure via a series of folding operations, in accordance with one embodiment of the invention. FIG. 4A shows a folded shorted patch antenna 400 that demonstrates the steps of folding over the patch 404 together with the ground plane 402. The example folded shorted patch antenna 400 includes a lower shorting wall 408 and a feed probe 406. The total resonant length of the folded shorted patch antenna 400 is still ˜λ₀/4. That is, the length spanning from the shorting wall formed by folding the ground plane 402 (referenced as the upper shorting wall 510 in FIG. 4B) to the radiating slot entrance is ˜λ₀/4, which indicates that the resonant frequency of an FSP antenna 504 (FIG. 4B) is similar to that of a conventional shorted patch antenna 200 (FIG. 2), as is borne out in numerical simulations and theoretical analysis. The actual length (i.e., electrical length) of the folded patch 404 has been reduced through the folding operation by 50% to ˜λ₀/8.

With continued reference to FIG. 4A, and referring now to FIG. 4B, by adding a new piece of the ground plane to the right of the folded ground plane 402 and pressing the folded patch 404 together to form a lower patch 505, a folded shorted patch antenna 504 is produced. Note that the original right part of the folded ground plane 402 (FIG. 4A) now serves as an upper shorting wall 510 and an upper patch 512 of the folded shorted patch antenna 504. The space between the upper patch 512 and the lower patch 505 comprise a radiating slot from which electromagnetic energy is concentrated and transmitted and/or received.

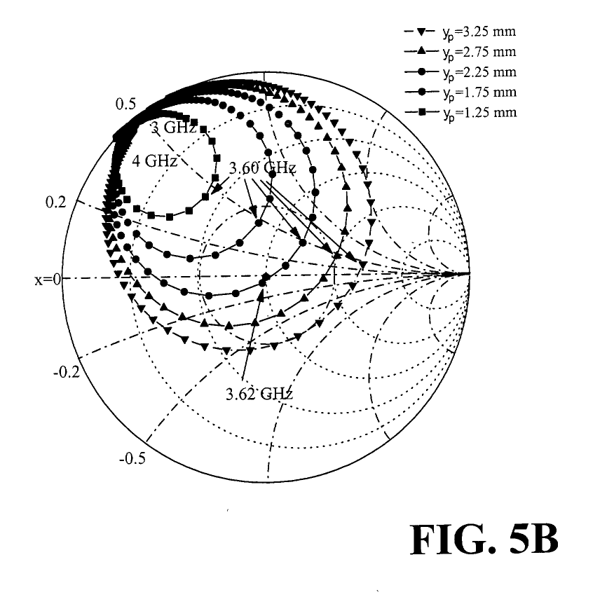

FIG. 5A depicts a general structure of the FSP antenna 504 shown in FIG. 4B. For simplicity, the discussions that follow will assume an implementation for the FSP antenna 504 in free space (i.e., an air dielectric substrate is approximated as a free space). The FSP antenna 504 includes a ground plane 502, a lower patch 505, an upper patch 512, a lower shorting wall 508, an upper shorting wall 510, and a feed probe 506. The ground plane 502 is preferably made of a conductive material such as aluminum, copper, and/or gold. The ground plane 502 is separated from the lower patch 505 by a dielectric substrate. The dielectric substrate described herein will be air, but can be glass or practically any other dielectric substrate.

The lower patch 505 is approximately parallel to the ground plane 502, and is shown with dimensions of width W₁, length L₁, and a height h₁ from the ground plane 502. One end of the lower patch 505 is in contact with the ground plane 502 via the lower shorting wall 508. The lower shorting wall 508 is shown with dimensions of width d₁.

A feed probe 506 can be electrically connected to the lower patch 505. The feed probe 506, which can be a coaxial cable, passes through the ground plane 502 and contacts the lower patch 505. For example, a coaxial cable having an inner and outer conductor will be connected to the lower patch 505 using the inner conductor (e.g., feed probe, with no connection to the ground plane) and the outer conductor will connect to the ground plane 502. The feed probe 506 connects a signal unit (not shown) to the lower patch 505 at various distances (yₚ) from the lower shorting wall 508 in the y-direction. The signal unit can be connected to the lower patch 505 in other ways, such as via a microstrip or a transmission line. The signal unit provides a signal of a selected frequency band to the lower patch 505, which creates a surface current in the lower patch 505. The density of the surface current is high near the region of the lower patch 505 in proximity to where the feed probe 506 contacts the lower patch 505. This current density decreases gradually along the length of the lower patch 505 in a direction away from the point where the feed probe 506 contacts the lower patch 505.

The FSP antenna 504 can be adjusted to match a defined feed input impedance, for example a 50-Ω feed, by changing the position of the feed probe 506. The input impedance of the FSP antenna fed at different positions (yₚ) is plotted in a Smith chart shown in FIG. 5B, with position adjustment in the x-direction having little effect on the impedance match. As shown, the impedance locus shrinks in size as the feed point moves closer to the lower shorting wall 508 (FIG. 5A). The asymmetry of the impedance locus about the x=0 axis in the Smith chart is due to the feed-probe reactance, which when read from the impedance locus is found to be near j25 Ω.

Returning to FIG. 5A, the FSP antenna 504 also includes an upper patch 512 that is approximately parallel to the lower patch 505. The upper patch 512 serves as a coupling patch (i.e., it is not fed by direct physical contact to a feed line or feed probe, but instead is excited through electromagnetic coupling). The upper patch 512 is shown with dimensions of width W₂, length L₂, and a height h₂ from the lower patch 505. The upper patch 512 is in contact with the ground plane 502 via the upper shorting wall 510. The upper shorting wall 510 is shown with a width of d₂. The electric field of the FSP antenna 504 is concentrated in the gap (i.e., radiation slot) between the lower and upper patches (505, 512). Surface-current distributions primarily occur on the top face of the lower patch 505, with smaller surface current distributions occurring on the inside face of the upper shorting wall 510. An electric-field concentration also exists between the edge of the lower patch 505 (the edge closest to the upper shorting wall 510) and the upper shorting wall 510. This is due at least in part to the effects of the relatively sharp edge of the lower patch 505 and the short distance between the edge and the upper shorting wall 510. Increasing the distance between the edge and the upper shorting wall 510 (i.e., a shortened L₁) can improve the impedance bandwidth of the FSP antenna 504.

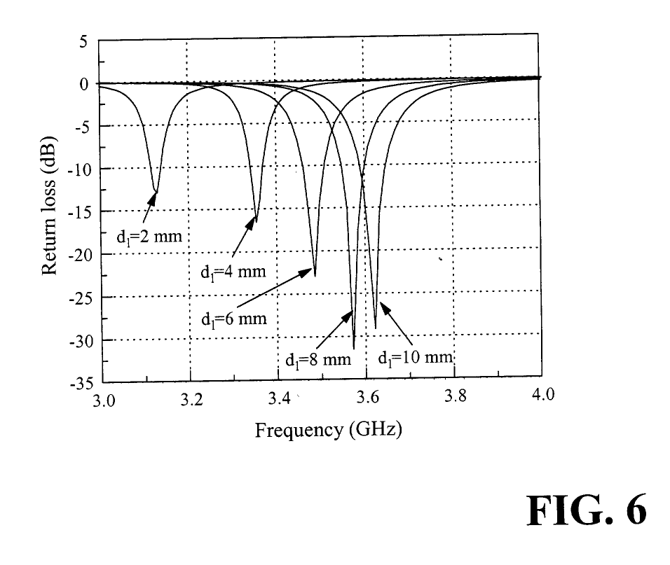

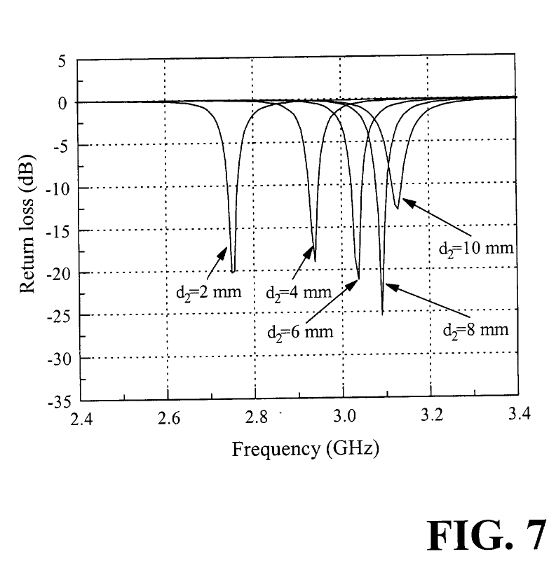

With continued reference to FIG. 5A throughout the discussion of FIGS. 6-8 that follow, the resonant frequency of the FSP antenna 504 can be lowered by slightly modifying the shape parameters of the FSP antenna 504, such as by reducing the widths of the two shorting walls 508 and 510 and/or adjusting the heights h₁, h₂ of the lower and upper patches 505, 512. FIGS. 6-8 provide illustrations of the effects on return loss and resonant frequency when simulating the modification of these dimensions through numerical analysis (e.g., via well-known transmission line match (TLM) and finite differential time domain (FDTD) simulations). FIG. 6 shows the simulated effects on resonant frequency and return loss with a varying d₁ dimension. For example, the width (d₁) of the lower shorting wall 508 is reduced while setting and maintaining the width (d₂) of the upper shorting wall 510 to be d₂=W₂ and the heights (h₁=h₂=1.5 millimeters (mm)) of the lower and upper patches 505, 512. As shown, the resonant frequency (shown at the inverted peaks) decreases as the width (d₁) of the lower shorting wall 508 becomes narrower (i.e., from 10 mm to 2 mm). Continuing the analysis, while setting and maintaining d₁=2 mm, the width of the upper shorting wall (d₂) can be changed, the effect of which is shown in FIG. 7. Again, the resonant frequency further decreases as d₂ reduces. One reason for the decrease of the resonant frequency with a reduction of the widths of the shorting walls (508, 510) is an increase in the inductance of the upper and lower patches (505, 512).

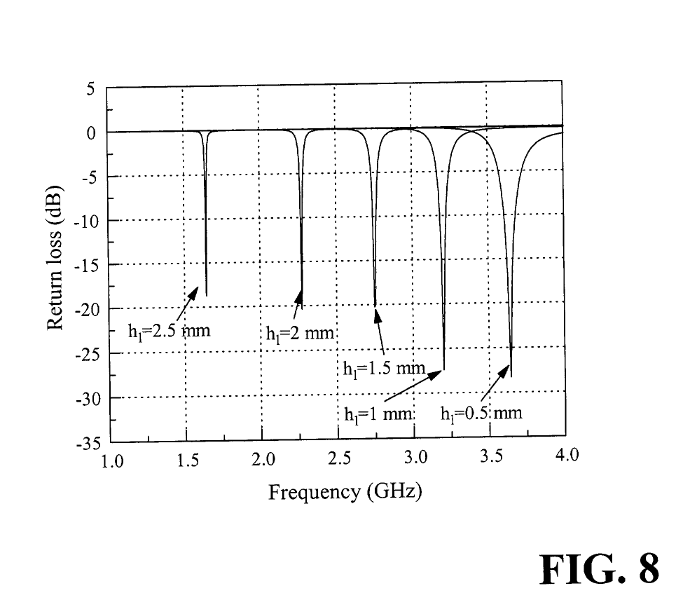

FIG. 8 demonstrates the effects of simulating an adjustment in the height (h₁) of the lower patch 505 while setting and maintaining d₁=d₂=2 mm and the total FSP antenna height (h₁+h₂)=3 mm. The variation of the return loss with h₁ and the difference in resonance frequency is as shown. It is noted that a variation in h₁ has a more significant impact on the resonant frequency than changes in d₁ and d₂. As the lower patch 505 moves toward the upper patch 512, the resonant frequency decreases. When the distance between the lower and upper patches (505, 512) is less than ⅕ of the total FSP antenna height, the resonant frequency reduces by more than a half of 3.6 GHz. One reason for the decrease in the resonant frequency with increase in h₁ (or a decrease in the distance between the lower and upper patches (505, 512)) is due to an enhancement of the capacitive coupling between the lower and upper patches (505, 512) as the upper and lower patches are brought closer to each other.

The position of the feed probe 506 will typically be adjusted for different antenna shape parameters to match, for example, a 50-Ω feed. Usually the radiation resistance increases with a decrease in antenna thickness and patch width because the radiated power decreases. Thus, the resonant resistance increases as the resonant frequency decreases. For the FSP antenna 504, the more the resonant frequency is reduced by varying the antenna shape parameters, the closer the feed probe position is shifted to the lower shorting wall 508.

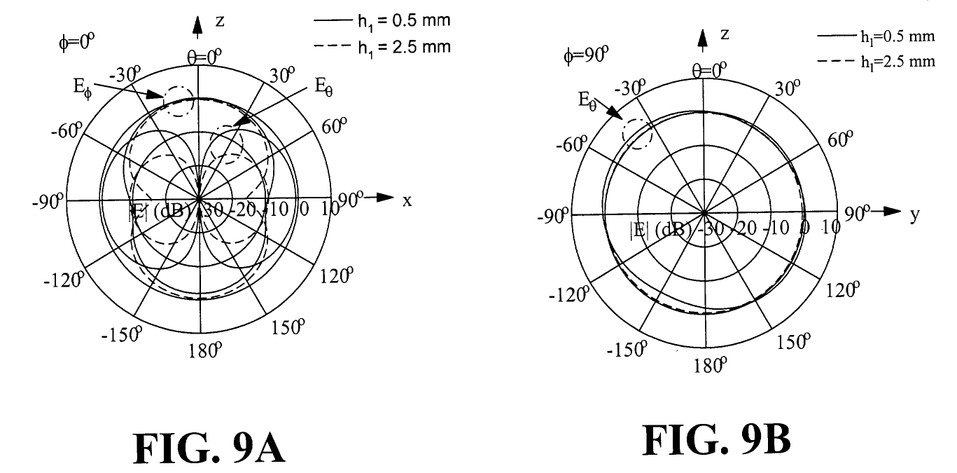

The simulated radiation patterns at resonant frequencies for h₁=0.5 mm at 3.63 GHz and with h₁=2.5 mm at 1.65 GHz are shown in FIGS. 9A and 9B. As shown in FIG. 9A, the radiation pattern represents the far-zone field in the x-z plane of a Cartesian coordinate system (x,y,z) while FIG. 9B includes a radiation pattern that represents the far-zone field in the y-z plane. In each plane, the far-zone field includes two orthogonal components E_{φ} and E_{θ}. E_{φ} in the y-z plane is zero due to symmetry, and thus there are only two lines indicated in FIG. 9B. For comparison, the radiation patterns at two different frequencies are plotted in each graph. The radiation patterns for the h₁=0.5 mm case is depicted using a solid line, and the h₁=2.5 mm case is depicted with a dotted line. The magnitude of electromagnetic energy, |E|, is in units of decibels (dB). The cross-polarized component is shown in FIG. 9A, and illustrates a more pronounced difference between the two cases: a lower h₁ corresponds to a higher cross-polarized level. Usually the cross polarized level increases with antenna thickness (i.e., total antenna height). When h₁ decreases, h₂ increases and the resonant frequency increases. As a result, the width of the radiating slot (h₂) further increases electrically, thus causing an increase in the cross-polarized level.

In the section that follows, the FSP antenna 504 (FIG. 5A) is described analytically by employing a transmission-line model. Also a qualitative analysis of the resonant frequency of the FSP antenna 504 is presented of the FSP antenna operation.

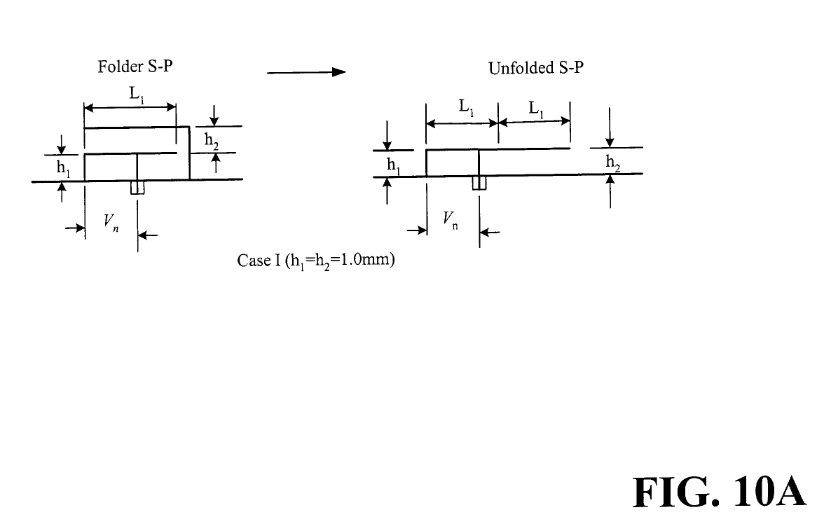

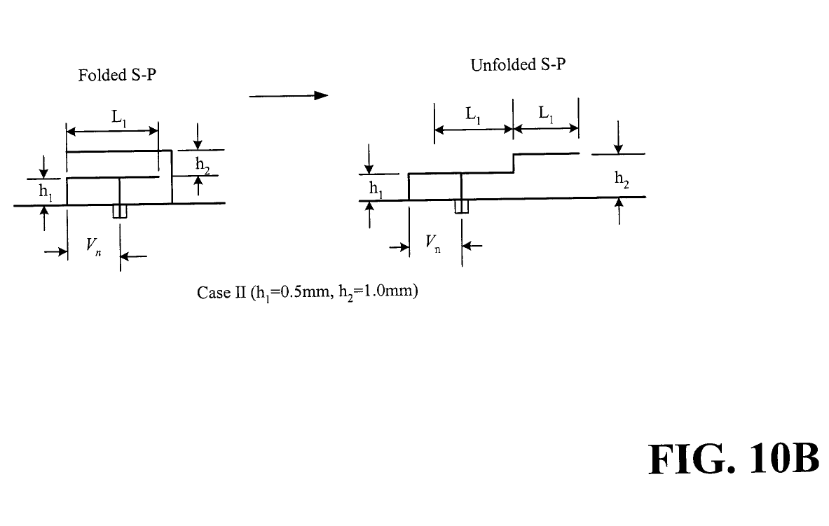

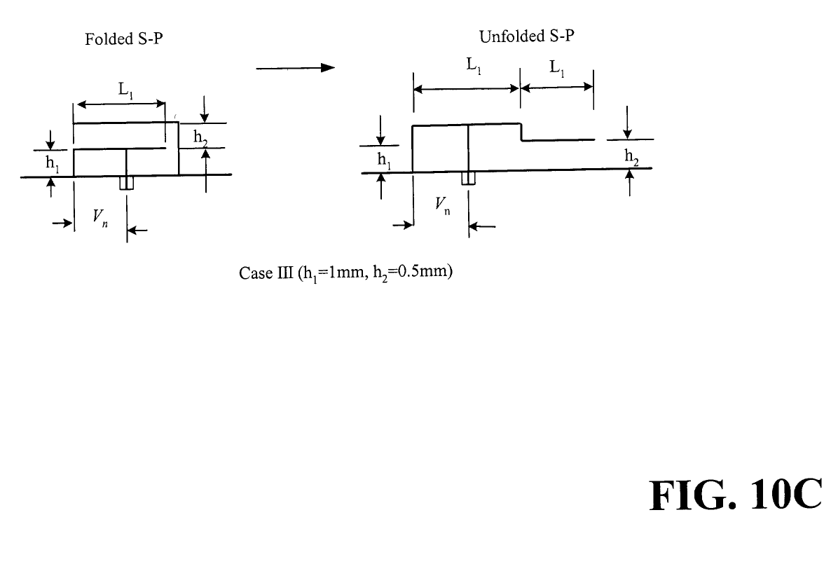

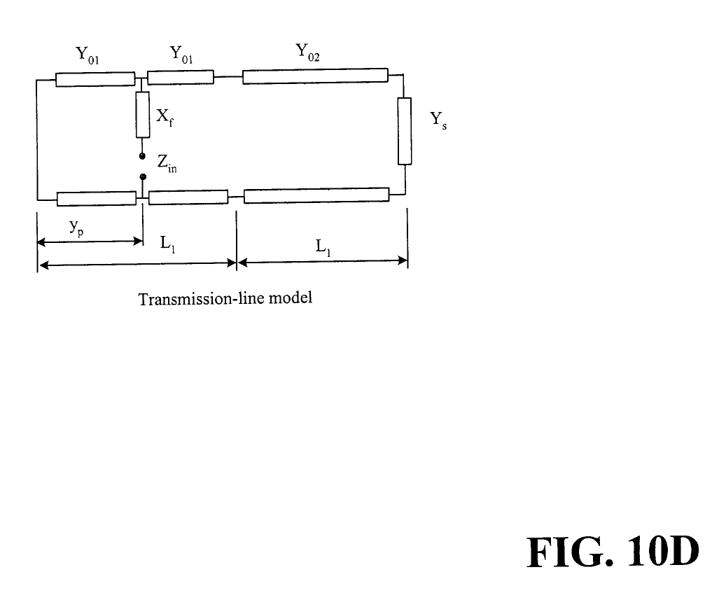

FIGS. 10A-10C present the FSP antenna 504 with three different patch-height arrangements, shown in FIGS. 10A-10C under the column heading, “folded S-P” (shorted patch): Case I (h₁=h₂=1.0 mm), Case II (h₁=0.5 mm, h₂=1.0 mm), and Case III (h₁=1.0 mm, h₂=0.5 mm). The “folded S-P” is unfolded to arrive at an “equivalent” (i.e., equivalent for transmission line analysis purposes) unfolded shorted patch (under the column heading, “unfolded S-P”) configuration associated with these three cases. Neglecting the effect of discontinuities, the “unfolded S-P” can be represented by a transmission-line equivalent circuit as shown in FIG. 10D. The input impedance of the “unfolded S-P” based on this equivalent circuit is obtained as follows:

Zᵢₙ=jX_{f}+Z₁ (1)

where X_{f} is the feed-probe reactance given by

$${X}_{f} = \frac{ω {μ}_{0} {h}_{1}}{2 π} [ ln ( \frac{2}{β {r}_{p}} ) - 0.57721 ] \qquad ( 2 )$$

with β=2π/λ₀ and rₚ=the feed-probe radius. Z₁ (=1/Y₁) is obtained from the transmission-line equivalent circuit, that is,

$$\begin{matrix}{Y}_{1} = {Y}_{01} \frac{1}{j tan ( β {y}_{p} )} + {Y}_{01} {Y}_{2} + \frac{j {Y}_{01} tan [ β ( {L}_{1} - {y}_{p} ) ]}{{Y}_{01} + j {Y}_{2} tan [ β ( {L}_{1} - {y}_{p} ) ]} & ( 3 ) \\ {Y}_{2} = {Y}_{02} {Y}_{s} + \frac{j {Y}_{02} tan ( β {L}_{1} )}{{Y}_{02} + j {Y}_{s} tan ( β {L}_{1} )} & ( 4 )\end{matrix}$$

where Y₀₁ and Y₀₂ are respectively the characteristic admittance of the lower and upper patches, and Yₛ=Gₛ+jBₛ. Here, Gₛ is the conductance associated with the power radiated from the radiating edge (or the radiating slot), and Bₛ is the susceptance due to the energy stored in the fringing field near the edge of the patch. In the calculations described herein, the following equations for Y(=Y₀₁ for h=h₁ or Y₀₂ for h=h₂), Gₛ, and Bₛ were used:

$$\begin{matrix}{Y}_{0} = \frac{W / h + 1.393 + 0.667 ln ( W / h + 1.444 )}{120 π} for W / h \geq 1 & ( 5 ) \\ {G}_{s} = \{ \begin{matrix}{W}^{2} / ( 90 {λ}_{0}^{2} ) & for & W \leq 0.35 {λ}_{0} \\ W / ( 120 {λ}_{0} ) - 1 / ( 60 {λ}_{0}^{2} ) & for & 0.35 {λ}_{0} \leq W \leq 2 {λ}_{0} \\ W / ( 120 {λ}_{0} ) & for & 2 {λ}_{0} \leq W\end{matrix} ( {h}_{2} \leq 0.02 {λ}_{0} ) & ( 6 )\end{matrix}$$

Bₛ=Y₀₂ tan(βΔl) (7)

$$Δ l = \frac{{ς}_{1} {ς}_{3} {ς}_{5}}{{ς}_{4}} {h}_{2} \qquad ( 8 )$$

where W is the width of the patch and coefficients ζ₁, ζ₃, ζ₄, ζ₅ can be found in the reference entitled, “Microstrip antenna design handbook”, by R. Garg et al., 2001, which is herein incorporated by reference.

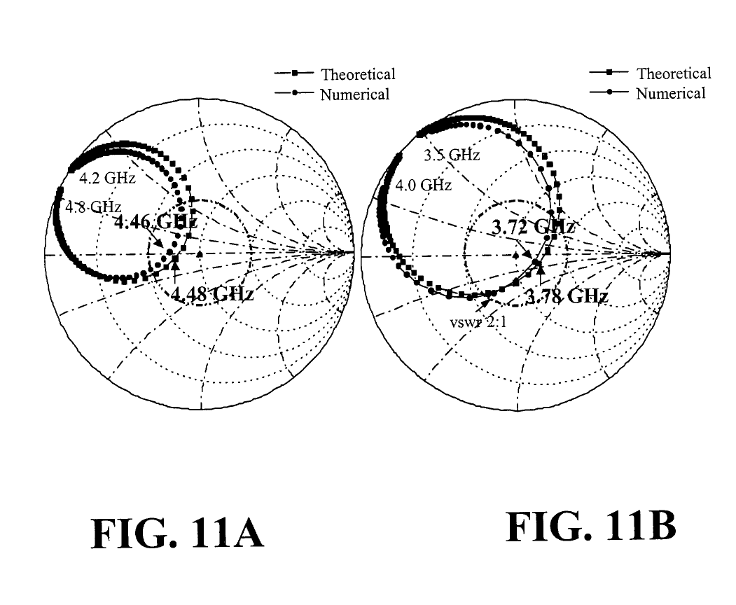

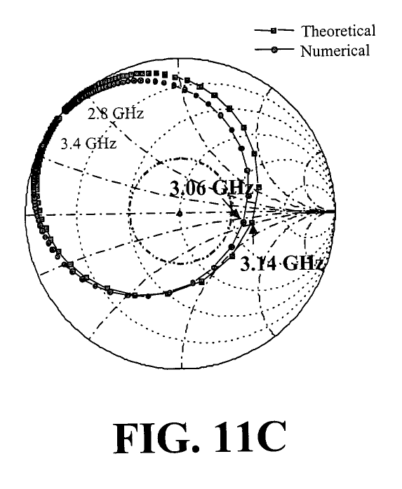

The theoretical results for the input impedance are obtained using the above analytical expressions and compared in FIGS. 11A-11C with numerical simulations for the above three cases. Note that the numerical results are obtained for the “folded S-P” shown in FIGS. 10A-10C. The theoretical and numerical results are in good agreement. The difference between the theoretical and simulated resonant frequencies is less than 3%. Also, it is again noted that the resonant frequency decreases as h₂/h₁ decreases. This can be explained qualitatively as follows. For simplicity, the effects of Y_{S}(Y_{S}<<Y₀ in practice) and X_{f} (focusing on the resonance of the patch alone) are neglected. As a result the “unfolded S-P” becomes a shorted transmission line loaded with an open transmission line. Assume that the resonant frequency is almost independent of the feeding position, yₚ=L₁ Thus, Y₁ becomes

$${Y}_{1} = {Y}_{01} \frac{1}{j tan ( β {L}_{1} )} + j {Y}_{02 } tan ( β {L}_{1} ) \qquad ( 9 )$$

At resonance, Y₁=0 leads to

Y₀₁/tan(βL₁)=Y₀₂ tan(βL₁) or tan(βL₁)=\sqrt{Y₀₁/Y₀₂} (10)

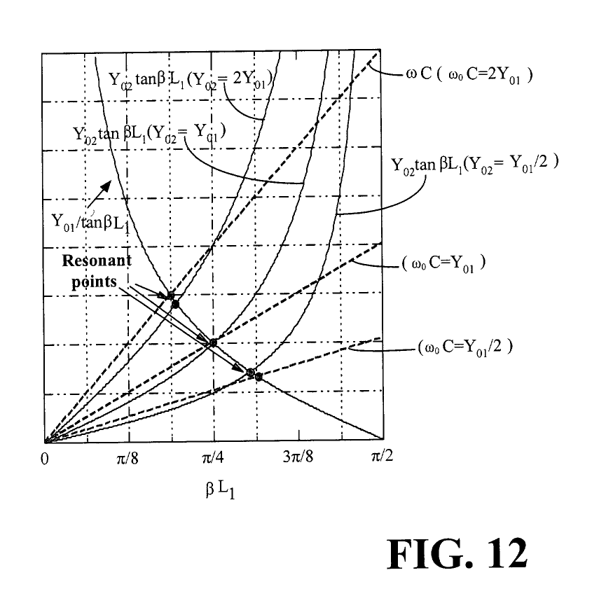

From equation 5 above, note that Y₀ is inversely proportional to h; therefore, from equation 10, it is determined that the resonant frequency varies proportionally with h₂/h₁. A graphical solution of equation 10 for resonant frequency is depicted in FIG. 12, where the intersection of the curves Y₀₁/tan(βL₁) and Y₀₂ tan(βL₁) implies a resonant point. FIG. 12 includes a plot of suseptance versus βL₁. Note that if Y₀₁=Y₀₂, then βL₁=π/4 corresponds to an antenna length of L₁=λ₀/8. Also note that an increase in Y₀₂ leads to a decrease in βL₁ if Y₀₁ remains unchanged.

With continued reference to FIGS. 10A-10C, considering the upper patch as a capacitive load provides additional insight for the above analysis. Replacing the upper patch with a capacitor C (not shown), which is connected between the radiating edge of the lower patch and the ground plane of the folded S-P antenna shown in FIGS. 10A-10C, equation 9 becomes

Y₀₁/tan(βL₁)=ωC. (11)

A graphical solution of equation 11 is also plotted in FIG. 12. As noted, the resonant frequency increases as the capacitance C increases. The resonant length of a capacitively loaded shorted patch will reduce to L₁=λ₀/8 if the loaded capacitance is C=Y₀₁/ω₀, where ω₀=3π/(4L₁)×10⁸ rad-s⁻¹ is obtained from βL₁=/4π. A decrease in h₂ is equivalent to an increase in the coupling capacitance between the upper and lower patches, thus eventually leading to a decrease in the resonant frequency.

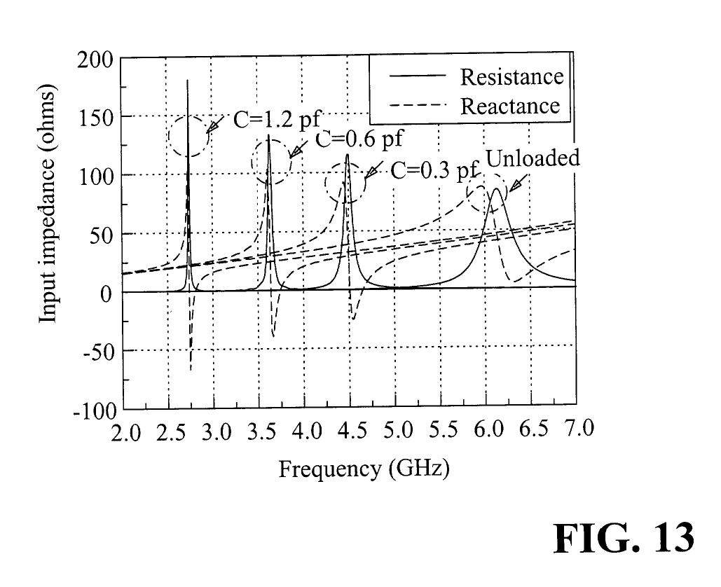

Equation 11 suggests an alternate embodiment for the FSP antenna 504 (FIG. 5A), wherein the resonant frequency can be reduced using a lumped capacitive load (e.g., a lumped capacitor between the radiating edge of the lower patch 505 and the ground plane 502 of the FSP antenna 504 of FIG. 5A, as described above). The simulated results for input impedance versus frequency are shown in FIG. 13, wherein the resistance is shown with a sold line and the reactance is shown with a dashed line. As expected, the resonant frequency decreases with an increase in the loaded capacitance. Comparing FIGS. 12 and 13, it is noted that the proportional relationship of the resonant frequencies among C=0.3, 0.6, and 1.2 picofarad (pf) is very similar to that (about 3:4:5) read from the graphical solutions of equation 11 when C=(Y₀₁/ω₀)/2, C=Y₀₁/ω₀, and C=2Y₀₁/ω₀. This demonstrates agreement between the numerical investigation and theoretical analysis described above.

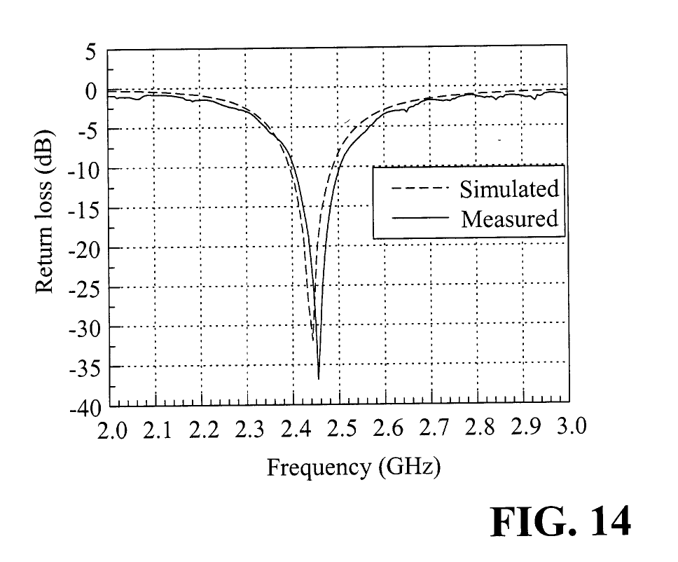

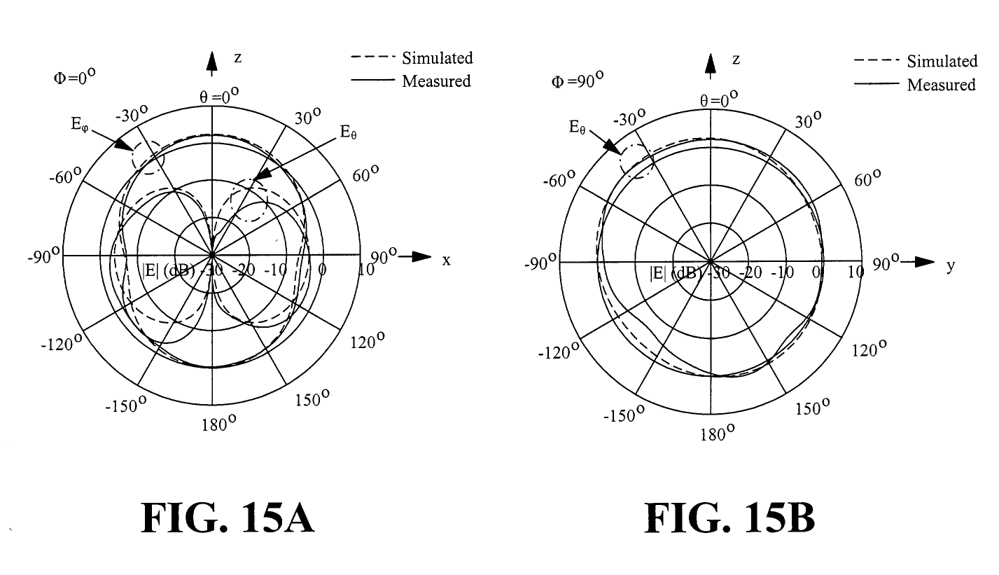

As one example implementation, a test FSP antenna was integrated in the package of a Bluetooth chip operating in the Bluetooth ISM band (2.4-2.483 GHz). The test FSP antenna was fabricated with a brass sheet with a thickness of 0.254 mm. The following FSP antenna dimensions were chosen: 15 mm×15 mm (≈λ₀/8×λ₀/8). To achieve the bandwidth (near 4%) required by the Bluetooth specifications, the total thickness of the antenna was selected to be 6 mm. By adjusting the height (h₁) of the lower patch to 2.85 mm, the resonant frequency can be tuned to approximately 2.44 GHz. The simulated and measured results for the return loss are plotted in FIG. 14. As shown, good performance agreement is obtained, and both of the simulated and measured 10-dB return-loss bandwidths cover the Bluetooth band. The radiation patterns simulated and measured in the xz- and yz-planes at 2.44 GHz were compared, as shown in FIGS. 15A-15B, and good agreement was again noted. There is a nearly omni-directional pattern for the co-polarized component, which is desirable for Bluetooth applications.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A patch antenna, comprising:
a ground plane;
a first shorting structure substantially perpendicular to and in contact with the ground plane;
a first conductor plate in contact with the first shorting structure and substantially parallel to the ground plane;
a second shorting structure substantially perpendicular and in contact with the ground plane; and
a second conductor plate in contact with the upper shorting structure and substantially parallel to the first conductor plate, the first conductor plate and the second conductor plate forming a radiation slot.

2. The patch antenna of claim 1, further comprising at least one of a probe feed and feed line in contact with the first conductor plate.

3. The patch antenna of claim 1, wherein the electrical length of the first and second conductor plate is each in the range of λ₀/8-λ₀/16.

4. The patch antenna of claim 1, wherein the electrical length of the first and second conductor plate is each approximately λ₀/16.

5. The patch antenna of claim 1, further including a dielectric positioned between the first conductor plate and the ground plane.

6. The patch antenna of claim 1, wherein the first and the second conductor plate, the first shorting structure, the second shorting structure, and the ground plane are comprised of at least one of aluminum, copper, gold, and silver.

7. The patch antenna of claim 1, wherein each of the first and the second shorting structures include at least one of a shorting wall and a shorting pin.

8. The patch antenna of claim 1, wherein the second conductor plate is physically disconnected from at least one of a probe feed and a probe line yet electrically excited by the at least one of the probe feed and the probe line through electromagnetic coupling.

9. A patch antenna, comprising:
a ground plane;
a first shorting structure in contact with the ground plane;
a first conductor plate in contact with the first shorting structure;
a second shorting structure in contact with the ground plane; and
a second conductor plate in contact with the second shorting structure and forming a radiation slot with the first conductor plate.

10. The patch antenna of claim 9, further comprising at least one of a probe feed and feed line in contact with the first conductor plate.

11. The patch antenna of claim 9, wherein the electrical length of the first and second conductor plate is each in the range of λ₀/8-λ₀/16.

12. The patch antenna of claim 9, wherein the electrical length of the first and second conductor plate is each approximately λ₀/16.

13. The patch antenna of claim 9, further including a dielectric positioned between the first conductor plate and the ground plane.

14. The patch antenna of claim 9, wherein the first and the second conductor plate, the first shorting structure, the second shorting structure, and the ground plane are comprised of at least one of aluminum, copper, gold, and silver.

15. The patch antenna of claim 9, wherein the first and the second shorting structure includes at least one of a shorting wall and a shorting pin.

16. The patch antenna of claim 9, wherein the second conductor plate is physically disconnected from at least one of a probe feed and a probe line yet electrically excited by the at least one of the probe feed and the probe line through electromagnetic coupling.

17. A patch antenna, comprising:
a ground plane; and
a shorting structure substantially perpendicular to and in contact with the ground plane; a conductor plate in contact with the shorting structure and substantially parallel to the ground plane, wherein the conductor plate is coupled to the ground plane with a reactive device.

18. The patch antenna of claim 17, wherein the electrical length of the conductor plate is approximately equal to λ₀/8.

19. The patch antenna of claim 17, wherein the reactive device is a capacitive device.

20. The patch antenna of claim 17, further comprising at least one of a probe feed and feed line in contact with the conductor plate.

21. The patch antenna of claim 17, further comprising means for feeding a signal to the conductor plate.

22. The patch antenna of claim 17, further including a dielectric positioned between the conductor plate and the ground plane.

23. The patch antenna of claim 17, wherein the conductor plate, the shorting structure, and the ground plane are comprised of at least one of aluminum, copper, gold, and silver.

24. The patch antenna of claim 17, wherein the shorting structure includes at least one of a shorting wall and a shorting pin.

25. A patch antenna, comprising:
a ground plane;
a first shorting structure substantially perpendicular to and in contact with the ground plane;
a first conductor plate in contact with the first shorting structure and substantially parallel to the ground plane, the first conductor plate having an electrical length of approximately λ₀/16;
a second shorting structure substantially perpendicular and in contact with the ground plane; and
a second conductor plate in contact with the upper shorting structure and substantially parallel to the first conductor plate, the second conductor plate having an electrical length of approximately λ₀/16, the first conductor plate and the second conductor plate forming a radiation slot.

26. A method for making a patch antenna, the method comprising the steps of:
connecting a first conductor plate to a first ground plane portion with a first shorting wall, the first conductor plate substantially parallel to the ground plane, the first conductor plate and the ground plane forming a first radiating slot; and
folding the first ground plane portion over the first conductor plate to form a second conductor plate that is substantially parallel to the first conductor plate and a second shorting structure substantially parallel to the first shorting structure, the folded portion located adjacent to the opening of the first radiating slot, the first conductor plate forming a second radiation slot having an opening opposite the first radiation slot.

27. The method of claim 26, further including the step of connecting the first ground plane portion to a second ground plane portion where the second shorting structure is formed from the first ground plane portion.

28. The method of claim 26, further including the step of forming the first conductor plate and the second conductor plate to an electrical length each of approximately λ₀/16.

29. A method for making a patch antenna, the method comprising the steps of:
connecting a first conductor plate to a ground plane with a first shorting structure, the first conductor plate substantially parallel to the ground plane, the first conductor plate having an electrical length of approximately λ₀/16; and
connecting a second conductor plate to the ground plane with a second shorting structure, the second conductor plate substantially parallel to the first conductor plate, the second conductor plate having an electrical length of approximately λ₀/16, the second conductor plate forming a radiation slot with the first conductor plate.

30. A method for making a patch antenna, the method comprising the steps of:
connecting a conductor plate to a ground plane with a shorting structure, the conductor plate substantially parallel to the ground plane; and
connecting the conductor plate to the ground plane with a capacitive device.

31. The method of claim 30, further including the step of forming the conductor plate to an electrical length of approximately wherein the electrical length of the conductor plate is approximately equal to λ₀/8.

32. A portable device comprising:
an enclosure including transceiver circuitry; and
an antenna mounted on the enclosure, the antenna including:
a ground plane;
a first shorting structure substantially perpendicular to and in contact with the ground plane;
a first conductor plate in contact with the first shorting structure and substantially parallel to the ground plane, wherein the first conductor plate is separated from the ground plane by a dielectric;
a second shorting structure substantially perpendicular and in contact with the ground plane;
a second conductor plate in contact with the upper shorting structure and substantially parallel to the first conductor plate, the first conductor plate and the second conductor plate forming a radiation slot; and
at least one of a probe feed and feed line in contact with the first conductor plate and in communication with the transceiver circuitry.

33. The portable device of claim 32, wherein the electrical length of the first and second conductor plate is each in the range of λ₀/8-λ₀/16.

34. The portable device of claim 32, wherein the electrical length of the first and 2 second conductor plate is each approximately λ₀/16.

35. A portable device comprising:
an enclosure including transceiver circuitry; and
an antenna mounted on the enclosure, the antenna including:
a ground plane;
a shorting structure substantially perpendicular to and in contact with the ground plane;
a conductor plate in contact with the shorting structure and substantially parallel to the ground plane, wherein the conductor plate is separated from the ground plane by a dielectric, wherein the conductor plate is coupled to the ground plane with a capacitive device; and
at least one of a probe feed and feed line in contact with the conductor plate.
